(19) United States
(12) Patent Application Publication
(10) Pub. No.: US 2010/0059963 A1
(43) Pub. Date: Mar. 11, 2010

(54) DUAL-DRIVE BICYCLE

(76) Inventor: Cheng-Chen Liao, Longtan Shiang (TW)

Correspondence Address: RABIN & Berdo, PC, 1101 14TH STREET, NW, SUITE 500, WASHINGTON, DC, 20005, US

(21) Appl. No.: 12/205,051

(22) Filed: Sep. 5, 2008

(51) Int. Cl. B62M 1/14

(52) U.S. Cl. 280/242.1

(57) ABSTRACT

A dual-drive bicycle has a front wheel provided with a transmission device including: an active sprocket at a top end or another portion of a steering post; a transmission sprocket on one side of an axle of the front wheel; and a chain connecting the active sprocket and the transmission sprocket for power transmission. When mounted at the top end of the steering post, the active sprocket has both ends of its axle extended and equipped with driving handlebars for steering the bicycle and driving the front wheel. When mounted at another portion of the steering post, the active sprocket has one end of its axle extended and equipped with a driving handlebar for driving the front wheel. Thus, in addition to a conventional rear-wheel driving structure, the bicycle has a front-wheel driving device allowing the bicycle to be selectively driven by the rear wheel, the front wheel or both.

### BACKGROUND OF THE INVENTION

1. Technical Field

The present invention relates to a dual-drive bicycle, and more particularly, to a bicycle including a transmission device provided at a front wheel thereof in addition to a conventional rear-wheel driving device, wherein the transmission device comprises an active sprocket, a chain and a transmission sprocket. The active sprocket has an axle whose one or two ends are extended and equipped with one or two driving handlebars allowing a user to drive the front wheel manually with one or both hands, so that the bicycle can be driven selectively by the rear wheel, the front wheel or a combination of both.

2. Description of Related Art

As environmental awareness prevails and oil prices continue to rise, power saving and reduction of carbon emission have become a worldwide movement. Hence, there is a fervently growing trend to ride bicycles, which consume neither gas nor electricity but serve to strengthen the riders' bodies. In response to this trend, bicycle manufacturers spare no efforts in developing new models and structures that are more ergonomic and more efficient in power transmission. Conventionally, most bicycles are driven by their rear wheels. A rider of a conventional bicycle sits astride a saddle and uses both feet to press pedals between a front wheel and a rear wheel, while holding steering bars above the front wheel with both hands. The pedals drive a sprocket connected therewith, so that a chain meshed with the sprocket drives another sprocket at the rear wheel, thereby propelling the rear wheel and generating power to move the bicycle forward. In the conventional form of single-wheel drive, pedaling efficiency can be increased by operating a speed-changing device coupled with the sprockets. However, since the bicycle is driven by only one wheel, the driving force is limited. In case the wheels are stuck in a muddy or stony road, the rear wheel alone is often insufficient to drive the bicycle out of entrapment. Or even worse, the rider may fall off the bicycle as a result. Moreover, cycling as a form of exercise is imperfect in that it trains mainly the riders' legs and does not provide sufficient exercise to the other limbs.

### BRIEF SUMMARY OF THE INVENTION

In view of the shortcomings associated with structures of the conventional bicycles, the inventor of the present invention thinks proactively and proposes an ingeniously designed “dual-drive bicycle” which can be driven by both a front wheel and a rear wheel. More specifically, the front wheel of the bicycle is provided with a transmission device comprising an active sprocket, a chain and a transmission sprocket. The active sprocket is provided unilaterally or bilaterally with one or two driving handlebars (depending on location of the active sprocket), which can be rotated by a single hand or both hands of a rider, so that the chain is driven to rotate the transmission sprocket at the front wheel, thereby rotating the front wheel. Thus, the bicycle can be selectively driven by the rear wheel, the front wheel or a combination of both to provide a fun riding experience.

### BRIEF DESCRIPTION OF THE SEVERAL VIEWS OF THE DRAWINGS

The structural features and practical functions of the present invention can be best understood by referring to the following detailed description of preferred embodiments in conjunction with the accompanying drawings, wherein:

FIG. 1 shows an embodiment of the present invention wherein an active sprocket is installed at a top end of a steering post of a bicycle; and

FIG. 2 shows another embodiment of the present invention wherein the active sprocket is installed at an appropriate position of the steering post of the bicycle other than the top end of the steering post.

### DETAILED DESCRIPTION OF THE INVENTION

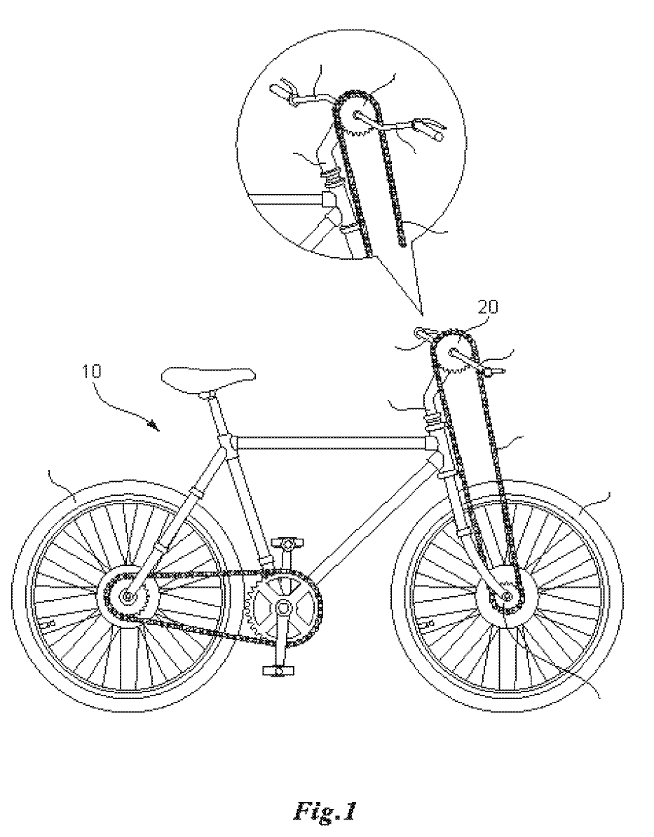

Referring to FIG. 1, a bicycle 10 according to the present invention has a front wheel 11 provided with a transmission device comprising an active sprocket 20, a chain 21 and a transmission sprocket 22. The transmission sprocket 22 is located on one side of an axle of the front wheel 11 and linked to the front wheel 11. The active sprocket 20 is mounted on a top end of a steering post 12 of the bicycle 10 and has an axle whose two ends are each extended and equipped with a driving handlebar 23. The chain 21 meshes with and thereby connects the active sprocket 20 and the transmission sprocket 22 for power transmission. A rider can hold the driving handlebars 23 with both hands to move the front wheel 11 to the left or right, thereby steering the bicycle 10. Meanwhile, the rider can also rotate the bilaterally provided driving handlebars 23 to drive the active sprocket 20, so that the chain 21 drives the transmission sprocket 22 below. Consequently, the front wheel 11 of the bicycle 10 is rotated to move the bicycle 10 forward.

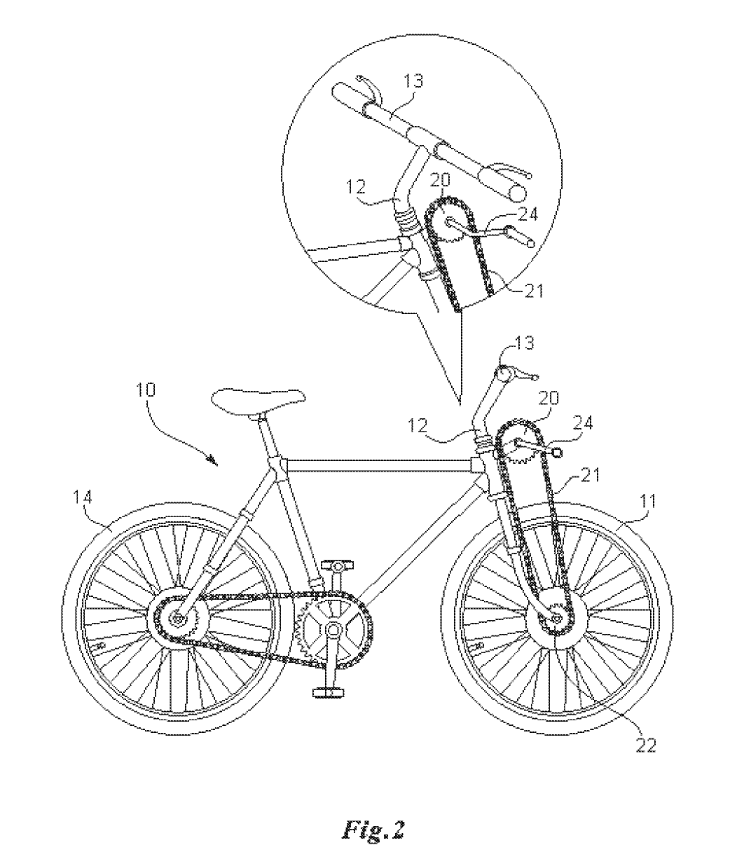

Refer now to FIG. 2 for a bicycle 10 according to another embodiment of the present invention. Therein, a transmission sprocket 22 is provided on a side of an axle of a front wheel 11, while an active sprocket 20 is installed at an appropriate position of a steering post 12 of the bicycle 10 other than a top end of the steering post 12. The active sprocket 20 has an axle whose one end is extended and equipped with a driving handlebar 24. A chain 21 meshes with and thereby connects the active sprocket 20 and the transmission sprocket 22 for power transmission. A transverse steering bar 13 is provided at the top end of the steering post 12 for steering the bicycle 10. A rider can ride the bicycle 10 by holding the transverse steering bar 13 with both hands while pedaling to drive a rear wheel 14 of the bicycle 10. Alternatively, the rider can hold the transverse steering bar 13 with one hand while holding and rotating the driving handlebar 24 with the other hand to drive the active sprocket 20. As a result, the chain 21 drives the transmission sprocket 22 below to rotate the front wheel 11 of the bicycle 10, thereby propelling the bicycle 10 forward.

While a brake system of the bicycle 10 has been well known in the art and is not a characteristic of the present invention, it will not be discussed in great detail herein.

According to the aforesaid structure, the rider not only can pedal in the conventional way to drive the rear wheel 14 with both feet and thereby propel the bicycle 10, but also can rotate the driving handlebars 23 or the driving handlebar 24 with both hands or a single hand to drive the front wheel 11 and thereby propel the bicycle 10 while allowing the rider's feet to rest. Furthermore, the rider can use his/her hands and feet simultaneously to rotate the front wheel 11 and the rear wheel 14, so that the bicycle 10 is driven by both wheels at the same time. In addition to the various operation modes that lead to a fun riding experience, the novel structure of the present invention provides the following advantageous effects:

(1) When driven by both wheels, the bicycle can have a higher driving force and speed which allow the bicycle to cope with various poor road conditions and have increased slope-climbing capability.

(2) To drive the bicycle with both wheels requires the rider to use both hands and feet, so that the bicycle can be operated more efficiently while all the rider's limbs are trained in a more balanced way. Compared with the conventional bicycles, the present invention is far more effective in helping the rider to lose weight and keep fit.

(3) Since the front wheel and the rear wheel can be driven independently as well as simultaneously, in case the chain for driving the rear wheel falls off, the rider can still propel the bicycle to his/her destination.

In conclusion, the present invention provides a novel structure that breaks through the conventional form of single-wheel drive of bicycles. According to the present invention, the front wheel and the rear wheel can be driven independently or simultaneously to effectively increase driving force and speed of the bicycle and produce superior training effects to the rider's entire body. As the present invention provides an inventive step, improvement and increased usefulness over the conventional bicycles, an application for patent of the present invention is lawfully filed for examination.

1. A dual-drive bicycle, comprising a transmission device provided at a front wheel of the bicycle, the transmission device comprising an active sprocket, a chain and a transmission sprocket, said transmission sprocket being provided on one side of an axle of the front wheel and linked to the front wheel, said active sprocket being provided at a top end of a steering post of the bicycle and having an axle whose two ends are each extended and equipped with a driving handlebar, and the chain meshing with and thereby connecting the active sprocket and the transmission sprocket for power transmission, wherein the driving handlebars bilaterally provided on the active sprocket are rotatable for driving the active sprocket, so that the chain drives the transmission sprocket to rotate the front wheel of the bicycle.

2. The dual-drive bicycle of claim 1, wherein the active sprocket is provided at a position of the steering post of the bicycle other than the top end of the steering post, and one end of the axle of the active sprocket is extended with and equipped the driving handlebar, in which the driving handlebar provided on the active sprocket is be rotatable for driving the active sprocket, so that the chain drives the transmission sprocket to rotating the front wheel of the bicycle.
